(19) United States
(12) Patent Application Publication
(10) Pub. No.: US 2022/0360288 A1
(43) Pub. Date: Nov. 10, 2022

(54) Mobile phone hook

(71) Applicant: Ning MENG, Guangdong (CN)

(72) Inventor: Ning MENG, Guangdong (CN)

(21) Appl. No.: 17/367,643

(22) Filed: Jul. 6, 2021

(30) Foreign Application Priority Data
May 10, 2021 (CN) 202120987140.8

(51) Int. Cl. H04B 1/3877; A47G 29/08

(52) U.S. Cl. CPC H04B 1/3877; A47G 29/08

(57) ABSTRACT

This invention provides a mobile phone hook including a soft hook body; the soft hook body includes an upper end hook portion and a lower end connecting portion; the upper end hook portion is provided with a hook opening. When using the mobile phone hook, the lower end connecting portion of the soft hook body can be placed on the back of a mobile phone and then covered by a mobile phone case; at this time, the upper end hook portion protrudes outwards from a gap between the mobile phone and the mobile phone case; the lower end connecting portion is gripped tightly by the gripping force between the mobile phone case and the mobile phone, and the protruded upper end hook portion can hook the mobile phone at suitable positions (e.g. the mobile phone can be hooked on the hook at the seat when taking a train or plane).

### BACKGROUND OF THE INVENTION

The present invention relates to a mobile phone hook.

With the popularization of mobile phones and development of communication technology, many people use smart phones to watch movies or TV shows on planes and trains. The mobile phones are placed on the seat-back tray tables on planes and trains when watching movies or TV shows, but as the tray tables are relatively low, it is necessary to lower one's head to watch. Although some people hold the mobile phones while watching, it is also necessary to lower one's head. Lower one's head for a prolonged period for looking at mobile phones affect the health of the cervical spine, and the hand would also get tired.

### BRIEF SUMMARY OF THE INVENTION

In view of the aforementioned technical problems, the present invention provides a mobile phone hook which comprises a soft hook body; the soft hook body comprises an upper end hook portion and a lower end connecting portion; the upper end hook portion is provided with a hook opening.

Furthermore, the lower end connecting portion is provided with adhesive.

Furthermore, the adhesive is self-adhesive that leaves no residue.

Furthermore, the soft hook body is made of paper, fabric or plastics.

The present invention has the following beneficial effects:

When using the mobile phone hook of the present invention, the lower end connecting portion of the soft hook body can be placed on the back of a mobile phone and then covered by a mobile phone case; at this time, the upper end hook portion protrudes outwards from a gap between the mobile phone and the mobile phone case; the lower end connecting portion is gripped tightly by the gripping force between the mobile phone case and the mobile phone, and the protruded upper end hook portion can hook the mobile phone at suitable positions (e.g. the mobile phone can be hooked on the hook at the seat when taking a train or plane).

### BRIEF DESCRIPTION OF THE DRAWINGS

FIG. 1 is a schematic view of the mobile phone hook of the present invention.

FIG. 2 is a schematic view showing installation of the mobile phone hook of the present invention.

FIG. 3 is a schematic view showing use of the mobile phone hook of the present invention.

### DETAILED DESCRIPTION OF THE INVENTION

The present invention is clearly and comprehensively explained herein with reference to the accompanying drawings in the embodiment of the present invention. Obviously, the embodiment that is described herein is only one of the possible embodiments of the present invention but not the only embodiment of the present invention. All other embodiments obtainable without any inventive effort by a person skilled in this field of art based on the embodiment of the present invention disclosed herein should also fall within the scope of protection of the present invention.

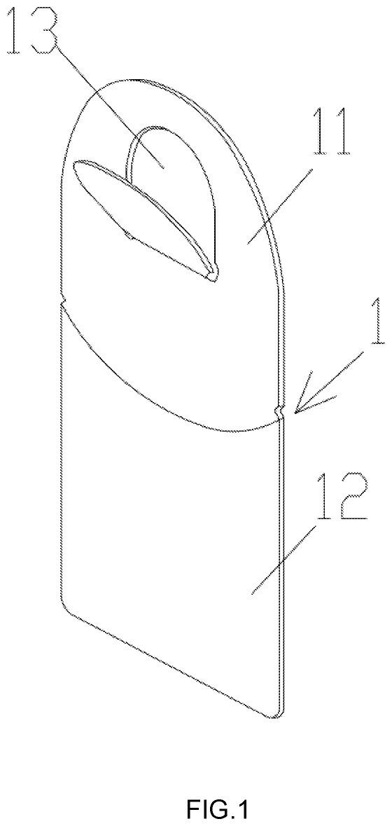

As shown in FIG. 1, the mobile phone hook comprises a soft hook body 1; the soft hook body 1 comprises an upper end hook portion 11 and a lower end connecting portion 12; the upper end hook portion 11 is provided by a hook opening 13.

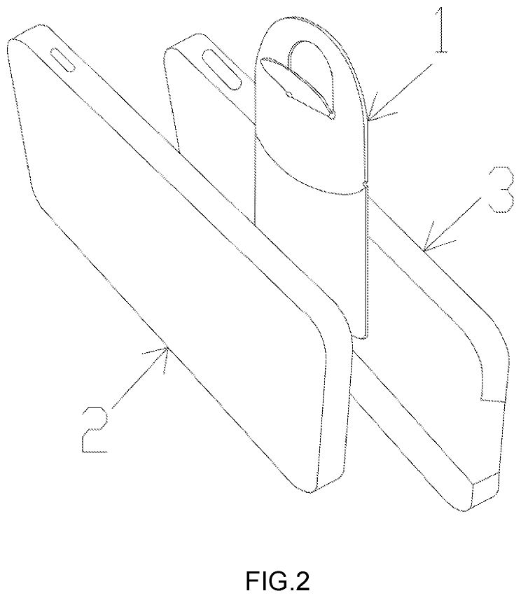

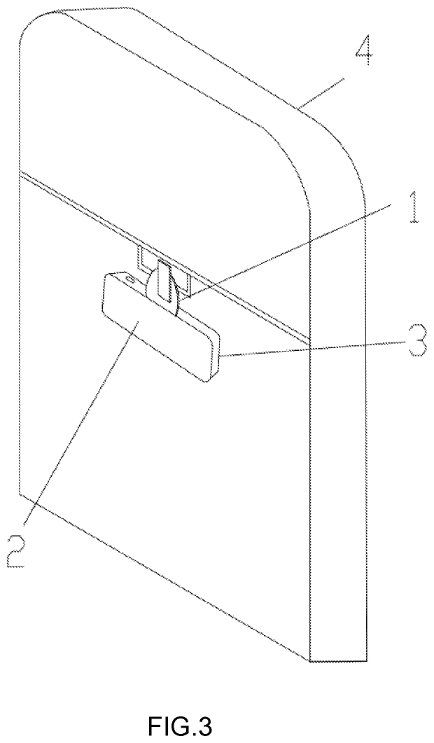

As shown in FIG. 2, when using the mobile phone hook of the present invention, the lower end connecting portion 12 can be placed on the back of a mobile phone 2 and then covered by a mobile phone case 3; at this time, the upper end hook portion 11 protrudes outwards from a gap between the mobile phone 2 and the mobile phone case 3; the lower end connecting portion 12 is gripped tightly by the gripping force between the mobile phone case 3 and the mobile phone 2, and the protruded upper end hook portion 11 can hook the mobile phone 2 at suitable positions (e.g. the mobile phone 2 can be hooked on the hook at the seat 4 when taking a train or plane, as shown in FIG. 3), thereby fulfilling users' needs.

Furthermore, the lower end connecting portion 12 is provided with adhesive. The adhesive can further stabilize the soft hook body 1 to prevent it from detaching from the mobile phone.

Furthermore, the adhesive is self-adhesive that leaves no residue. The adhesive in form of self-adhesive that leaves no residue allows the user to detach the soft hook body from the mobile phone without making the mobile phone dirty.

Furthermore, the soft hook body 1 is made of paper, fabric or plastics.

While the embodiment of the present invention has been described and illustrated to the fullest extent, the persons skilled in the art may make any changes, modifications, alternations and variations without departing from the principle and spirit of the present invention. The scope of the present invention is defined by the accompanying claims and equivalents thereof.

What is claimed is:

1. A mobile phone hook comprising a soft hook body; the soft hook body comprises an upper end hook portion and a lower end connecting portion; the upper end hook portion is provided with a hook opening.

2. The mobile phone hook as in claim 1, wherein the lower end connecting portion is provided with adhesive.

3. The mobile phone hook as in claim 2, wherein the adhesive is self-adhesive that leaves no residue.

4. The mobile phone hook as in claim 1, wherein the soft hook body is made of paper, fabric or plastics.

5. The mobile phone hook as in claim 2, wherein the soft hook body is made of paper, fabric or plastics.

6. The mobile phone hook as in claim 3, wherein the soft hook body is made of paper, fabric or plastics.
